(19) United States
(12) Patent Application Publication
(10) Pub. No.: US 2024/0349727 A1
(43) Pub. Date: Oct. 24, 2024

(54) SYNERGY BETWEEN MIXTURES OF ISOTHIOCYANATES AND COMMERCIAL FUNGICIDES

(71) Applicant: AGROSUSTAIN SA, Renens (CH)

(72) Inventors: Olga DUBEY, Préverenges (CH); Sylvain DUBEY, Préverenges (CH); Florian GUIGNARD, Nyon (CH); Matteo PEDRAZZETI, Lausanne (CH)

(21) Appl. No.: 18/576,319

(22) PCT Filed: Jul. 4, 2022
(86) PCT No.: PCT/EP2022/068489

§ 371 Date: Jan. 3, 2024

(30) Foreign Application Priority Data
Jul. 5, 2021 (EP) 21183776.0

(51) Int. Cl. A01N 47/46; A01N 37/34; A01N 43/36; A01N 43/54; A01N 43/56; A01N 43/653; A01N 47/14; A01N 47/44; A01P 3/00

(52) U.S. Cl. CPC A01N 47/46; A01N 37/34; A01N 43/36; A01N 43/54; A01N 43/56; A01N 43/653; A01N 47/14; A01N 47/44; A01P 3/00

(57) ABSTRACT

The present invention relates to fungicidal mixtures of isothiocyanate derivatives and commercial fungicides, and to compositions comprising such mixtures and methods for using such mixtures as fungicides.

### FIELD OF THE INVENTION

The present invention relates to fungicidal mixtures of isothiocyanate derivatives and commercial fungicides, and to compositions comprising such mixtures and methods for using such mixtures as fungicides.

### BACKGROUND OF THE INVENTION

Human population is increasing each year and is about to reach 8.6 billion by 2030. To maintain high levels of food production, farmers have to use external treatments, such as: 1) chemical pesticides that have high efficiency, accessible costs, but reveal negative impact on the environment and human health; 2) biological pesticides having no harmful effect on environment, but showing low efficiency (less than 60%, compared to existing chemical pesticide) and high costs. That makes biological pesticides not accessible for many countries and opens possibilities to develop and bring to market novel organic treatments that reveal high efficiency and accessible costs and are environmentally friendly.

In the last decades, some biological approaches were developed to prevent B. cinerea in the field, e.g. the application of Bacillus subtilis and Trichoderma harzanium, but they are poorly used in farming due to their low efficiency.

In western European agriculture, the commonly used bio-preventive fungicides are copper and sulphur. These fungicides are costly to apply due to the need to reapply after each precipitation. In addition, high concentrations of these metals in soil have negative impacts on the environment.

As a consequence, it is crucial to provide an alternative to these techniques, by being more respectful towards the environment, as well as a highly efficient preventive treatment against fungal pathogens.

Plant fungal pathogens are one of the agronomical threats that leads to severe food losses yearly. The efficiency of fungal pathogens is caused by their easy dispersal in nature, rapid attachment on the host surface and fast germ tube development that promotes penetration in plants.

Plants, on the other hand, have developed several defence mechanisms against fungal pathogens e.g. necrotrophs: a) prevention of pathogen penetration; b) increased levels of reactive oxygen species; c) induction of defence hormones, such as jasmonate, ethylene, salicylic and abscisic acid. Additionally, some plants are synthetizing fungitoxic compounds that prevent fungal development on plant surface and stop disease formation. Identification of plant compounds with strong antifungal activity can lead to development of novel biological fungicides that can, potentially, replace currently existing chemical treatments.

Order of Brassicales consists of economically important plants that are broadly distributed and used as food source. This group of plants was shown to have a unique set of secondary metabolites—glucosinolates. In the last decades, glucosinolate derivatives were shown to have anti-cancerous, anti-inflammatory and insecticidal properties.

In CAROLINE MUELLER: “Role of glucosinolates in plant invasiveness”, PHYTOCHEMISTRY REVIEWS, KLUWER ACADEMIC PUBLISHERS, DO, vol. 8, no. 1, 28 Oct. 2008 (2008-10-28), pages 227-242, XP019686442, ISSN: 1572-980X, it is disclosed that many plants have been intentionally or accidentally introduced to new habitats where some of them now cause major ecological and economic threats to natural and agricultural ecosystems. The potential to become invasive might depend on plant characteristics, as well as on specific interactions with other organisms acting as symbionts or antagonists, including other plants, microbes, herbivores, or pollinators. The invasion potential furthermore depends on abiotic conditions in the habitat. Several species of the Brassicaceae, well known for their glucosinolate-myrosinase defence system, are invasive species. Various factors are reviewed here that might explain why these species were so successful in colonizing new areas. Specific emphasis is laid on the role of glucosinolates and their hydrolysis products in the invasion potential. This particular defence system is involved specifically in plant-plant, plant-microbe and plant-insect interactions. Most research has been done on the mechanisms underlying invasion success of Alliaria petiolata and Brassica spp., followed by Bunias orientalis and Lepidium draba. Some examples are also given for plants that are not necessarily considered as invasive, but which were well investigated with respect to their interference potential with their biotic environment. For each species, most likely a combination of different plant characteristics enhanced the competitive abilities and led to diverse invasive phenotypes.

WO 2018/204435 A1 (DOW AGROSCIENCES LLC [US]) 8 Nov. 2018 (2018-11-08) discloses a fungicidal composition containing a fungicidally effective amount of the compound of Formula I, (S)-I,I-bis(4-fluorophenyl)propan-2-yl (3-acetoxy-4-methoxypicolinoyl)-L-alaninate, and at least one fungicide selected from the group consisting of tebuconazole, prothioconazole, difenconazole, epoxiconazole, mefentrifluconazole, benzovindiflupyr, penthiopyrad, fluxapyroxad, bixafen, fluopyram, picoxystrobin, pyraclostrobin, azoxystrobin, mancozeb and chlorothalonil, provides synergistic control of selected fungi.

WO 2020/011750 A1 (UNIV LAUSANNE [CH]) relates to the field of biological fungicides with a broad range of antifungal activity coming from plant extracts from the order of Brassicales or molecules revealing similar chemical structure. In particular, Applicants surprisingly provided a new usage of a combination of sulfonyl and sulfinyl containing aliphatic glucosinolates, their by-products and synthetic analogues as efficient antifungal compounds with broad spectrum of activity.

The control of plant diseases caused by fungal plant pathogens is extremely important in achieving high crop efficiency. Plant disease damage to ornamental, vegetable, field, cereal and fruit crops can cause significant reduction in productivity and thereby result in increased costs to the consumer. In addition to often being highly destructive, plant diseases can be difficult to control and may develop resistance to commercial fungicides. Combinations of fungicides are often used to facilitate disease control, to broaden spectrum of control and to retard resistance development. Furthermore, certain rare combinations of fungicides demonstrate a greater-than-additive (i.e. synergistic) effect to provide commercially important levels of plant disease control. The advantages of particular fungicide combinations are recognized in the art to vary, depending on such factors as the particular plant species and plant disease to be treated, and whether the plants are treated before or after infection with the fungal plant pathogen.

Accordingly new advantageous combinations are needed to provide a variety of options to best satisfy particular plant disease control needs.

### BRIEF DESCRIPTION OF THE INVENTION

In the present invention, Applicants have identified fungicidal mixtures of glucosinolates derivatives namely isothiocyanates (ITC) and commercial fungicides, and synergistic compositions comprising such mixtures as well as methods for using such mixtures as fungicides. A strong fungitoxic effect on a broad range of fungal pathogens was observed. This combination of products can be used as a new line of biological fungicides.

One of the objects of the present invention is to provide a synergistic fungicidal composition comprising:
(a) at least one component being the mixture of 1-isothiocyanato-8(methylsulfonyl)-octane (8MSOOH) and 1-isothiocyanato-8-(methylsulfinyl)-octane (8MSOH); and
(b) at least one additional synthetic fungicidal component selected from Mancozeb, Dodine, Chlorothalonil, Tebuconazole, Captan, Cyprodinil, Fludioxonil, Fluxypyroxad and Pyrimethanil, phosphorous acid and salts thereof or mixtures thereof.

Another object of the present invention is to provide a method for controlling a plant disease caused by a fungal plant pathogen comprising applying to the plant or portion thereof, or to the plant seed, a fungicidally effective amount of the synergistic fungicidal composition of the invention.

A further object of the invention is to provide an use of a synergistic composition comprising the combination of:
(a) at least one component being the mixture of 1-isothiocyanato methyl sulfinyl-octane (8MSOH) and 1-isothiocyanato methyl sulfonyl-octane (8MSOOH); and
(b) at least one additional synthetic fungicidal component selected from Mancozeb, Dodine, Chlorothalonil, Tebuconazole, Captan, Cyprodinil, Fludioxonil, Fluxypyroxad and Pyrimethanil, phosphorous acid and salts thereof or mixtures thereof, in the prevention or treatment of fungal pathogens in plants.

Other objects and advantages of the invention will become apparent to those skilled in the art from a review of the ensuing detailed description, which proceeds with reference to the following illustrative drawings, and the attendant claims.

### BRIEF DESCRIPTION OF THE FIGURES

FIG. 1: Results of in vitro fungitoxic activity (curative) of the ITC (8MSOH/8MSOOH) and synthetic fungicides (Dodine, Tebuconazole and Chlorothalonil) alone and in combination on Penicilium digitatum, including the lowest combination index for the synergy. The normal line represents the fit of the ITC data, the dashed line the fit of the fungicide data and the bold line the fit of the combo (fungicide+ITC) data.

FIG. 2: Results of in vitro fungitoxic activity (curative) of the ITC (8MSOH/8MSOOH) and synthetic fungicides (Pyrimethanil, Chlorothalonil and Tebuconazole) alone and in combination on Rhizoctonia solani, including the lowest combination index for the synergy. The normal line represents the fit of the ITC data, the dashed line the fit of the fungicide data and the bold line the fit of the combo (fungicide+ITC) data.

FIG. 3: Results of in vitro fungitoxic activity (curative) of the ITC (8MSOH/8MSOOH) and synthetic fungicides (Dodine, Pyrimethanil and Tebuconazole) alone and in combination on Alternaria radicina, including the lowest combination index for the synergy. The normal line represents the fit of the ITC data, the dashed line the fit of the fungicide data and the bold line the fit of the combo (fungicide+ITC) data.

FIG. 4: Results of in vitro fungitoxic activity (curative) of the ITC (8MSOH/8MSOOH) and synthetic fungicides (Tebuconazole and Dodine) alone and in combination on Geotrichum candidum and Botrytis cinerea, including the lowest combination index for the synergy. The normal line represents the fit of the ITC data, the dashed line the fit of the fungicide data and the bold line the fit of the combo (fungicide+ITC) data.

FIG. 5: Results of in vitro fungitoxic activity (preventive) of the ITC (8MSOH/8MSOOH) and synthetic fungicides (Tebuconazole and Chlorothalonil) alone and in combination on Geotrichum candidum and Rhizoctonia solani, including the lowest combination index for the synergy. The normal line represents the fit of the ITC data, the dashed line the fit of the fungicide data and the bold line the fit of the combo (fungicide+ITC) data.

FIG. 6: Results of in vitro fungitoxic activity (curative) of the ITC (8MSOH/8MSOOH) and synthetic fungicides (Fluxypyroxad, Dodine and Tebuconazol) alone and in combination on Lasiodiplodia pseudotheobromae, including the lowest combination index for the synergy. The normal line represents the fit of the ITC data, the dashed line the fit of the fungicide data and the bold line the fit of the combo (fungicide+ITC) data.

FIG. 7: Results of in vitro fungitoxic activity (curative) of the ITC (8MSOH/8MSOOH) and synthetic fungicides (Cyprodinil and Fludioxonil) alone and in combination on Lasiodiplodia pseudotheobromae, including the lowest combination index for the synergy. The normal line represents the fit of the ITC data, the dashed line the fit of the fungicide data and the bold line the fit of the combo (fungicide+ITC) data.

FIG. 8: Results of in vitro fungitoxic activity (curative) of the ITC (8MSOH/8MSOOH) and synthetic fungicides (Captan and Tebuconazole) alone and in combination on Fusarium verticilloides, including the lowest combination index for the synergy. The normal line represents the fit of the ITC data, the dashed line the fit of the fungicide data and the bold line the fit of the combo (fungicide+ITC) data.

FIG. 9: Results of in vitro fungitoxic activity (curative) of the ITC (8MSOH/8MSOOH) and synthetic fungicide (Chlorothalonil) alone and in combination on Colletotrichum acutatum, including the lowest combination index for the synergy. The normal line represents the fit of the ITC data, the dashed line the fit of the fungicide data and the bold line the fit of the combo (fungicide+ITC) data.

FIG. 10: Results of in vitro fungitoxic activity (curative) of the ITC (8MSOH/8MSOOH) and synthetic fungicide (Tebuconazole) alone and in combination on Penicillium commune, including the lowest combination index for the synergy. The normal line represents the fit of the ITC data, the dashed line the fit of the fungicide data and the bold line the fit of the combo (fungicide+ITC) data.

FIG. 11: Results of in vitro fungitoxic activity (curative) of the ITC (8MSOH/8MSOOH) and synthetic fungicides (Mancozeb and Dodine) alone and in combination on Plectosphaerella cucumerina, including the lowest combination index for the synergy. The normal line represents the fit of the ITC data, the dashed line the fit of the fungicide data and the bold line the fit of the combo (fungicide+ITC) data.

### DETAILED DESCRIPTION OF THE INVENTION

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control.

Unless defined otherwise, all technical and scientific terms used herein have the same meaning as is commonly understood by one of skill in art to which the subject matter herein belongs. As used herein, the following definitions are supplied in order to facilitate the understanding of the present invention.

As used herein, the terms “comprises,” “comprising,” “includes,” “including,” “has,” “having”, “contains” or “containing” or any other variation thereof, are intended to cover a non-exclusive inclusion and is used in the sense of include, that is to say permitting the presence of one or more features or components. For example, a composition, process, method, that comprises a list of elements is not necessarily limited to only those elements but may include other elements not expressly listed or inherent to such composition, process, method.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The presence of broadening words and phrases such as “one or more,” “at least,” “but not limited to” or other like phrases in some instances shall not be read to mean that the narrower case is intended or required in instances where such broadening phrases may be absent.

A “fungus” is a eukaryote that digests food externally and absorbs nutrients directly through its cell walls. Most fungi reproduce by spores and have a body (thallus) composed of microscopic tubular cells called hyphae. Fungi are heterotrophs and, like animals, obtain their carbon and energy from other organisms. Some fungi obtain their nutrients from a living host (plant or animal) and are called biotrophs; others obtain their nutrients from dead plants or animals and are called saprotrophs (saprophytes, saprobes). Some fungi infect a living host but kill host cells in order to obtain their nutrients; these are called necrotrophs.

“Pathogenic fungi” also referred herein as “fungal pathogens” are fungi that cause disease in plants, humans or other organisms. Approximately 300 fungi are known to be pathogenic to humans. The study of fungi pathogenic to humans is called “medical mycology”. Although fungi are eukaryotic, many pathogenic fungi are microorganisms. The study of fungi and other organisms pathogenic to plants is called plant pathology.

There are thousands of species of plant pathogenic fungi that collectively are responsible for 70% of all known plant diseases. Plant pathogenic fungi are parasites, but not all plant parasitic fungi are pathogens. Plant parasitic fungi obtain nutrients from a living plant host, but the plant host doesn't necessarily exhibit any symptoms. Plant pathogenic fungi are parasites and cause diseases characterized by symptoms.

“Fungicides” are biocidal chemical compounds or biological organisms used to kill parasitic fungi or their spores (defined herein as fungitoxic). A fungistatic inhibits their growth. Fungi can cause serious damages in agriculture, resulting in critical losses of yield, quality, and profit. Fungicides are used both in agriculture and medicine to fight fungal infections in animals or humans. Chemicals used to control oomycetes, which are not fungi, are also referred to as fungicides, as oomycetes use the same mechanisms as fungi to infect plants. Fungicides can either be contact, translaminar or systemic. Contact fungicides are not taken up into the plant tissue and protect only the plant where the spray is deposited. Translaminar fungicides redistribute the fungicide from the upper, sprayed leaf surface to the lower, unsprayed surface. Systemic fungicides are taken up and redistributed through the xylem vessels. Few fungicides move to all parts of a plant. Some are locally systemic, and some move upwardly.

“Fungistatics” are anti-fungal agents that inhibit the growth of fungus (without killing the fungus). The term fungistatic may be used as both a noun and an adjective. Fungistatics have applications in agriculture, the food industry, the paint industry, and medicine.

By “plants” is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

As referred to in the present disclosure and claims, “plant” includes members of Kingdom Plantae, particularly seed plants (Spermatopsida), at all life stages, including young plants (e.g., germinating seeds developing into seedlings) and mature, reproductive stages (e.g., plants producing flowers and seeds). Portions of plants include geotropic members typically growing beneath the surface of the growing medium (e.g., soil), such as roots, tubers, bulbs and corms, and also members growing above the growing medium, such as foliage (including stems and leaves), flowers, fruits and seeds.

As referred to herein, the term “seedling”, used either alone or in a combination of words means a young plant developing from the embryo of a seed or bud of a vegetative propagation unit such as tuber, corm or rhizome.

Phosphorous acid and its salts are not found naturally, but are closely related to common substances that are found throughout the environment. The active ingredients are directly toxic to the target fungi, and also appear to increase the effectiveness of the plants' defense mechanisms.

One skilled in the art recognizes that because in the environment and under physiological conditions salts of chemical compounds are in equilibrium with their corresponding non-salt forms, salts share the biological utility of the non-salt forms. When the compounds forming the present mixtures and compositions contain acidic or basic moieties, a wide variety of salts can be formed, and these salts are useful in the present mixtures and compositions for controlling plant diseases caused by fungal plant pathogens (i.e. are agriculturally suitable). When a compound contains a basic moiety such as an amine function, salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound contains an acidic moiety such as a carboxylic acid or an alcohol such as phenol, salts include those formed with organic or inorganic bases such as pyridine, triethylamine or ammonia, or amides, hydrides, hydroxides or carbonates of sodium, potassium, lithium, calcium, magnesium or barium.

The composition of the invention is fungitoxic and/or fungistatic in plants and can be applied to plant cultures in the field or for in vitro implementation thereof.

It is usually accepted that “synergy” occurs when the combined action of two or more agents is greater than the sum of their individual effects. In other words, synergy is said to occur when the combined action of two or more agents is greater than could have been predicted based on the performance of the agents when used alone.

“Isothiocyanate” is the chemical group —N═C═S, formed by substituting the oxygen in the isocyanate group with a sulphur. Many natural isothiocyanates from plants are produced by enzymatic conversion of metabolites called glucosinolates. These natural isothiocyanates, such as allyl isothiocyanate, are also known as mustard oils. An artificial isothiocyanate, phenyl isothiocyanate, is used for amino acid sequencing in the Edman degradation. In the context of the present invention, the term isothiocyanate or ITC represents the mixture of 1-isothiocyanato methyl sulfinyl-octane (8MSOH) and 1-isothiocyanato methyl sulfonyl-octane (8MSOOH).

One object of the present invention is to provide a synergistic fungicidal composition comprising:
(a) at least one component being the mixture of 1-isothiocyanato methyl sulfinyl-octane (8MSOH) and 1-isothiocyanato methyl sulfonyl-octane (8MSOOH); and
(b) at least one additional synthetic fungicidal component selected from selected from Mancozeb, Dodine, Chlorothalonil, Tebuconazole, Captan, Cyprodinil, Fludioxonil, Fluxypyroxad and Pyrimethanil, phosphorous acid and salts thereof or mixtures thereof.

Preferably, component (b) is selected from Pyrimethanil, Tebuconazole, Chlorothalonil, Dodine, Cyprodinil, Fluxapyroxad, Captan, Mancozeb and Fludioxonil.

Even more preferably, component (b) is selected from Tebuconazole, Captan, Cyprodinil and Dodine.

According to an embodiment of the invention, component (a) is present at a ratio 1-isothiocyanato methyl sulfinyl-octane/1-isothiocyanato methyl sulfonyl-octane of 50-50 vol./vol. Preferably, the ratio of 1-isothiocyanato methyl sulfinyl-octane/1-isothiocyanato methyl sulfonyl-octane is 99/1 vol./vol.

According to another embodiment, component (a) namely the mixture of 1-Isothiocyanato-8-(methylsulfonyl)-octane (8MSOOH) and 1-Isothiocyanato-8-(methylsulfinyl)-octane (8MSOH) represents between 0.5-7% in concentration of said combination of said two active compounds. Preferably, between 1-4% in concentration of the combination of said two active compounds and most preferably, between 1-2% in concentration of the combination of said two active compounds.

According to an embodiment of the invention, the synergistic fungicidal composition further comprises at least one additional component selected from the group consisting of a surfactant, a solid diluent and/or a liquid diluent.

According to yet another embodiment, the weight ratio of component (a) to component (b) is from 1:5 to 3137:1.

In particular, the weight ratio of component (a) to pyrimethanil is from 6:1 to 980:1.

According to another embodiment, the weight ratio of component (a) to Tebuconazole is from 2:1 to 2500:1.

According to a further embodiment, the weight ratio of component (a) to chlorothalonil is from 1:5 to 880:1.

According to another embodiment, the weight ratio of component (a) to dodine is from 1:1 to 103:1.

According to a further embodiment, the weight ratio of component (a) to mancozeb is from 1:1 to 10:1.

According to yet a further embodiment, the weight ratio of component (a) to captan is from 1:1 to 2:1.

According to yet another embodiment, the weight ratio of component (a) to cyprodinil is from 22:1 to 207:1.

According to a further embodiment, the weight ratio of component (a) to fludioxonil is from 398:1 to 3137:1

According to yet another embodiment, the weight ratio of component (a) to fluxapyroxad is from 4:1 to 31:1.

Another object of the invention is to provide a method for controlling a plant disease caused by a fungal plant pathogen comprising applying to the plant or portion thereof, or to the plant seed, a fungicidally effective amount of the synergistic fungicidal composition of the invention as defined above.

Preferably, the fungal plant pathogen is selected from the group consisting of Fusarium spp., Geotrichum candidum, Botrytis cinerea, Rhizoctonia solani, Penicillium digitatum Alternaria radicina, Fusarium verticilloides, Penicillium commune, Plectosphaerella cucumerina, Colletotrichum acutatum and Lasiodiplodia pseudotheobromae.

A still further object of the invention is to provide an use of a synergistic composition comprising the combination of:
(a) at least one component being the mixture of 1-isothiocyanato methyl sulfinyl-octane (8MSOH) and 1-isothiocyanato methyl sulfonyl-octane (8MSOOH); and
(b) at least one additional synthetic fungicidal component selected from Mancozeb, Dodine, Chlorothalonil, Tebuconazole, Captan, Cyprodinil, Fludioxonil, Fluxypyroxad and Pyrimethanil, phosphorous acid and salts thereof or mixtures thereof, in the prevention or treatment of fungal pathogens in plants.

According to an embodiment of the invention, component (a) is present at a ratio 1-isothiocyanato methyl sulfinyl-octane/1-isothiocyanato methyl sulfonyl-octane of 50-50 vol./vol. Preferably, the ratio of 1-isothiocyanato methyl sulfinyl-octane/1-isothiocyanato methyl sulfonyl-octane is 99/1 vol./vol.

According to another embodiment of the invention, the synergistic composition further comprising at least one additional component selected from the group consisting of a surfactant, a solid diluent and/or a liquid diluent.

According to one embodiment, the weight ratio of component (a) to component (b) is from 1:5 to 3137:1.

In particular, the weight ratio of component (a) to pyrimethanil is from 6:1 to 980:1.

According to another embodiment, the weight ratio of component (a) to Tebuconazole is from 2:1 to 2500:1.

According to a further embodiment, the weight ratio of component (a) to chlorothalonil is from 1:5 to 880:1.

According to another embodiment, the weight ratio of component (a) to dodine is from 1:1 to 103:1.

According to a further embodiment, the weight ratio of component (a) to mancozeb is from 1:1 to 10:1.

According to yet a further embodiment, the weight ratio of component (a) to captan is from 1:1 to 2:1.

According to yet another embodiment, the weight ratio of component (a) to cyprodinil is from 22:1 to 207:1.

According to a further embodiment, the weight ratio of component (a) to fludioxonil is from 398:1 to 3137:1

According to yet another embodiment, the weight ratio of component (a) to fluxapyroxad is from 4:1 to 31:1.

Synergistic fungicidal compositions include those where component (a) and component (b) are present in a fungicidally effective amount and the weight ratio of component (a) to component (b) is from 1:5 to 3137:1. These compositions are particularly effective for controlling plant diseases caused by Fusarium spp., Geotrichum candidum, Botrytis cinerea, Rhizoctonia solani, Penicillium digitatum Alternaria radicina, Fusarium verticilloides, Penicillium commune, Plectosphaerella cucumerina, Colletotrichum acutatum and Lasiodiplodia pseudotheobromae fungal plant pathogens.

The mixture of components of this invention is generally used to provide fungicidal active ingredients in compositions, i.e. formulations, with at least one additional component selected from the group consisting of surfactants, solid diluents and liquid diluents, formulants, excipients, which serve as a carrier. The formulation or composition ingredients are selected to be consistent with the physical properties of the active ingredients, mode of application and environmental factors such as soil type, moisture and temperature.

According to one embodiment, component (a) and component (b) and one or more other biologically active compound or agent can be formulated separately and applied separately or applied simultaneously in an appropriate weight ratio, e.g., as a tank mix; or

(ii) component (a) and component (b) and/or one or more other biologically active compound or agent can be formulated together in the proper weight ratio.

Preferably, carriers or diluents to be used in the present invention are phytologically-acceptable.

As used herein, the term “phytologically-acceptable” formulations refer to compositions, diluents, excipients, and/or carriers that are generally applicable for use with any part of a plant during any part of its life cycle, including but not limited to seeds, seedlings, plant cells, plants, or flowers. The formulations can be prepared according to procedures, methods and formulas that are conventional in the agricultural arts. Following the teachings of the present invention, the person skilled in the agricultural and/or chemical arts can readily prepare a desired composition. Most commonly, the fungicide composition of the present invention can be formulated to be stored, and/or applied, as aqueous or non-aqueous suspensions or emulsions prepared neat or from concentrated formulations of the compositions. Water-soluble, water-suspendable or emulsifiable formulations can also be converted into or formulated as solids (e.g., wettable powders), which can then be diluted into a final formulation. In certain formulations, the synergistic fungicidal composition of the present invention can also be provided in growth media, e.g., in vitro media for growth of plant or other types of cells, in laboratory plant growth media, in soil, or for spraying on seeds, seedlings, roots, stems, stalks, leaves, flowers or the entire plant.

These phytologically-acceptable formulations are produced in a known manner, for example by mixing the synergistic fungicidal composition of the invention with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water. Liquefied gaseous extenders or carriers are to be understood as meaning liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example, nonionic and anionic emulsifiers, such as polyoxyethylene fatty acid esters, polyoxyethylene fatty alcohol ethers, for example alkylaryl polyglycol ethers, alkyl-sulphonates, alkyl sulphates, arylsulphonates, or else protein hydrolysates. Suitable dispersants are: for example, lignin-sulphite waste liquors, methylcellulose, ethylcellulose and hydroxypropylmethyl cellulose.

The synergistic fungicidal composition according to the invention can be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra-low volume (ULV) liquid, ultra-low volume (ULV) suspension, water dispersible granules or tablets, water dispersible powder for slurry treatment, water soluble granules or tablets, water soluble powder for seed treatment and wettable powder. These compositions include not only compositions that are ready to be applied to the plant or seed to be treated by means of a suitable device, such as a spraying or dusting device, but also concentrated commercial compositions that must be diluted before application to the crop.

In a preferred embodiment of the invention, the synergistic fungicidal composition can be specifically applied on fruits and vegetables in storage facilities with an ultrasonic fogger. The ultrasonic fogger is a device that is using ultrasonic sound waves to break water into very small droplets (<10 um) and sprays it into the air as a dense cold fog (i.e. not resulting from boiling water). Examples of ultrasonic foggers and systems are i.e. described in the following U.S. patents: U.S. Pat. Nos. 4,042,016; 4,058,253; 4,118,945; 4,564,375; 4,667,465; 4,702,074; 4,731,990; 4,731,998; 4,773,846; 5,454,518; 6,854,661. Usually an ultrasonic fogger includes: a generally cylindrical body having an axial bore with an outlet at a front face of the body; a gas supply and a liquid supply coupled to the bore; at least a portion of the front face having a curved convex contour, the front face having a flat central annular region surrounding the outlet of the bore; and a resonator spaced from and opposing the outlet end of the bore. Such devices are commonly used to control humidity level in greenhouses, to deliver nutrients to plant in aeroponic cultures or to create optimal humidity levels in houses.

Applicants demonstrated that this technique can be used to apply products used for the extension of fruits and vegetables freshness in storage facilities e.g. natural fungicides. This technology, permits to efficiently treat fruits and vegetables that are not accessible to the treatments applied by spray or other applications, due to their packaging (i.e. it cannot be easily sprayed directly because fruits and vegetables are stored e.g. in container or because spraying might damage the fruits and vegetables).

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake.

The formulations will typically contain effective amounts of active ingredients, diluent and surfactant within the following approximate ranges known to the skilled person which add up to 100 percent by weight.

The synergistic fungicidal composition of the invention present several advantages, they reveal fungitoxic and/or fungistatic activity against environmental, plant, storage and medical fungal pathogens.

The synergistic fungicidal composition used in the present invention has been shown to extend shelf-life by a minimum of one week for fruits, vegetables and cut flowers infected by fungal pathogens in storage facilities. Compounds used (i.e. mixture of ITC) were shown to be not toxic for insects and humans. The composition of the invention is easily applicable with a specific impact on the ripening perishable food and no extra installation cost is required. The synergistic fungicidal composition of the invention is of interest to storage companies (i.e. reducing costs in packaging), the timber industry, gardeners and farmers.

Thus, the synergistic fungicidal composition of the invention is to be used as a fungitoxic and/or as a fungistatic agent in plants. The synergistic fungicidal composition of the invention to be used as a fungicide has shown a large efficacy in treating various plants or plant families (hosts). Indeed, the synergistic fungicidal composition of the invention can be used in treating more than 1400 species of agronomical important crops or plants, including order of Solanales, Rosales, Vitales, Poales etc.

The synergistic fungicidal composition of the invention may be used with any part of a plant during any part of its life cycle, including but not limited to seeds, seedlings, plant cells, plants, or flowers.

According to the invention, all plants and plant parts can be treated.

Among the plants that can be protected by the synergistic fungicidal composition of the invention, mention may be made of major field crops like corn, soybean, cotton, Brassica oilseeds such as Brassica napus (e.g. canola), Brassica rapa, B. juncea (e.g. mustard) and Brassica carinata, rice, wheat, sugarbeet, sugarcane, oats, rye, barley, millet, triticale, flax, vine and various fruits and vegetables of various botanical taxa such as Rosaceae sp. (for instance pip fruit such as apples and pears, but also stone fruit such as apricots, cherries, almonds and peaches, berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for instance banana trees and plantings), Rubiaceae sp. (for instance coffee), Theaceae sp., Sterculiceae sp., Rutaceae sp. (for instance lemons, oranges and grapefruit); Solanaceae sp. (for instance tomatoes, potatoes, peppers, eggplant), Liliaceae sp., Compositiae sp. (for instance lettuce, artichoke and chicory—including root chicory, endive or common chicory), Umbelliferae sp. (for instance carrot, parsley, celery and celeriac), Cucurbitaceae sp. (for instance cucumber—including pickling cucumber, squash, watermelon, gourds and melons), Alliaceae sp. (for instance onions and leek), Cruciferae sp. (for instance white cabbage, red cabbage, broccoli, cauliflower, brussel sprouts, pak choi, kohlrabi, radish, horseradish, cress, Chinese cabbage), Leguminosae sp. (for instance peanuts, peas and beans beans—such as climbing beans and broad beans), Chenopodiaceae sp. (for instance mangold, spinach beet, spinach, beetroots), Malvaceae (for instance okra), Asparagaceae (for instance asparagus); horticultural and forest crops; ornamental plants and flowers including cut flowers; grass i.e. golf fields, turf, as well as genetically modified homologues of these crops.

For example, the synergistic fungicidal composition of the present invention can be used for controlling common fungal diseases such as powdery mildew, rust, downy mildew, and anthracnose on field crops, fruit trees and vegetables.

In addition, the synergistic fungicidal composition of the invention can be used for the treatment of resistant diseases, mainly for the control of wheat powdery mildew, rice blast, rice smut, melon powdery mildew, tomato powdery mildew, apple rust, watermelon Anthracnose and flower powdery mildew. Besides the synergistic fungicidal composition has very good control effects against cucumber downy mildew, grape downy mildew, scab, anthrax, and spotted defoliation.

In a particular embodiment of the invention, the synergistic fungicidal composition of the invention is to be used in the treatment or prevention of tree diseases, caused by fungal pathogens e.g. panama disease of banana, ash dieback.

Besides, the synergistic fungicidal composition of the invention can be used directly in the field in plant cultures but also in vitro for example for implementation in plant cultures.

Compositions of component (a) together with component (b) can be further mixed with one or more other biologically active compounds or agents including insecticides, nematocides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising a fungicidally effective amount of a mixture of component (a) together with component (b) and a biologically effective amount of at least one additional biologically active compound or agent and can further comprise at least one of a surfactant, a solid diluent or a liquid diluent. The other biologically active compounds or agents can also be separately formulated in compositions comprising at least one of a surfactant, solid or liquid diluent. For compositions of the present invention, one or more other biologically active compounds or agents can be formulated together with both of components (a) and (b) to form a premix, or one or more other biologically active compounds or agents can be formulated separately from components (a) and (b) and the formulations combined together before application (e.g., in a spray tank) or, alternatively, applied in succession.

Examples of such biologically active compounds or agents with which compositions of component (a) with component (b) can be formulated are: insecticides such as abamectin, acephate, acetamiprid, acetoprole, aldicarb, amidoflumet, amitraz, avermectin, azadirachtin, azinphos-methyl, bifenthrin, bifenazate, bistrifluron, buprofezin, carbofuran, cartap, chinomethionat, chlorfenapyr, chlorfluazuron, chlorantraniliprole, 3-bromo-1-(3-chloro-2-pyridinyl)-N-[4-cyano-2-methyl-6-[[(1-methylethyl)amino]carbonyl]phenyl]-1H-pyrazole-5-carboxamide, 3-bromo-1-(3-chloro-2-pyridinyl)-N-[4-cyano-2-methyl-6-[(methylamino)carbonyl]phenyl]-1H-pyrazole-5-carboxamide, 3-chloro-1-(3-chloro-2-pyridinyl)-N-[4-cyano-2-methyl-6-[(methylamino)carbonyl]phenyl]-1H-pyrazole-5-carboxamide, 3-chloro-1-(3-chloro-2-pyridinyl)-N-[4-cyano-2-methyl-6-[[(1-methylethyl)amino]carbonyl]phenyl]-1H-pyrazole-5-carboxamide, chlorpyrifos, chlorpyrifos-methyl, chlorobenzilate, chromafenozide, clothianidin, cyflumetofen, cyfluthrin, beta-cyfluthrin, cyhalothrin, gamma-cyhalothrin, lambda-cyhalothrin, cyhexatin, cypermethrin, cyromazine, deltamethrin, diafenthiuron, diazinon, dicofol, dieldrin, dienochlor, diflubenzuron, dimefluthrin, dimethoate, dinotefuran, diofenolan, emamectin, endosulfan, esfenvalerate, ethiprole, etoxazole, fenamiphos, fenazaquin, fenbutatin oxide, fenothiocarb, fenoxycarb, fenpropathrin, fenpyroximate, fenvalerate, fipronil, flonicamid, flubendiamide, flucythrinate, tau-fluvalinate, flufenerim, flufenoxuron, fonophos, halofenozide, hexaflumuron, hexythiazox, hydramethylnon, imicyafos, imidacloprid, indoxacarb, isofenphos, lufenuron, malathion, metaflumizone, metaldehyde, methamidophos, methidathion, methomyl, methoprene, methoxychlor, methoxyfenozide, metofluthrin, monocrotophos, nitenpyram, nithiazine, novaluron, noviflumuron, oxamyl, parathion, parathion-methyl, permethrin, phorate, phosalone, phosmet, phosphamidon, pirimicarb, profenofos, profluthrin, propargite, protrifenbute, pymetrozine, pyrafluprole, pyrethrin, pyridaben, pyridalyl, pyrifluquinazon, pyriprole, pyriproxyfen, rotenone, ryanodine, spinetoram, spinosad, spiridiclofen, spiromesifen, spirotetramat, sulprofos, tebufenozide, tebufenpyrad, teflubenzuron, tefluthrin, terbufos, tetrachlorvinphos, thiacloprid, thiamethoxam, thiodicarb, thiosultap-sodium, tolfenpyrad, tralomethrin, triazamate, trichlorfon, triflumuron; nematocides such as aldicarb, imicyafos, oxamyl and fenamiphos; bactericides such as streptomycin; acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and biological agents including entomopathogenic bacteria, such as Bacillus thuringiensis sub sp. aizawai, Bacillus thuringiensis sub sp. kurstaki, and the encapsulated delta-endotoxins of Bacillus thuringiensis(e.g., Cellcap, MPV, MPVII); entomopathogenic fungi, such as green muscardine fungus; and entomopathogenic virus including baculovirus, nucleopolyhedro virus (NPV) such as HzNPV, AfNPV; and granulosis virus (GV) such as CpGV.

Mixtures of this invention and compositions thereof can be applied to plants genetically transformed to express proteins toxic to invertebrate pests (such as Bacillus thuringiensis delta-endotoxins). The effect of the exogenously applied fungicidal mixtures of this invention may be synergistic with the expressed toxin proteins.

General references for agricultural protectants (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U. K., 2003 and The BioPesticide Manual, 2nd Edition, L. G. Copping, Ed., British Crop Protection Council, Farnham, Surrey, U. K., 2001.

For embodiments where one or more of these various mixing partners are used, the weight ratio of these various mixing partners (in total) to the mixture of component (a) with component (b) is typically between 1:100 and 3000:1. Of note are weight ratios between 1:30 and 300:1 (for example ratios between 1:1 and 30:1). It will be evident that including these additional components may expand the spectrum of diseases controlled beyond the spectrum controlled by a mixture of component (a) with component (b).

The compositions of this invention are useful as plant disease control agents. The present invention therefore further comprises a method for controlling plant diseases caused by fungal plant pathogens comprising applying to the plant or portion thereof to be protected, or to the plant seed or vegetative propagation unit to be protected, an effective amount of a mixture of the invention or a fungicidal composition comprising said mixture.

Plant disease control is ordinarily accomplished by applying an effective amount of a mixture of this invention, typically as a formulated composition, either pre- or post-infection, to the portion of the plant to be protected such as the roots, stems, foliage, fruit, seeds, tubers or bulbs, or to the media (soil or sand) in which the plants to be protected are growing. The mixtures can also be applied to seeds to protect the seeds and seedlings developing from the seeds. The mixtures can also be applied through irrigation water to treat plants.

Rates of application for these mixtures and compositions of this invention can be influenced by many factors of the environment and should be determined under actual use conditions. Foliage can normally be protected when treated at a rate of from less than about 1 g/ha to about 5,000 g/ha of active ingredients. Seed and seedlings can normally be protected when seed is treated at a rate of from about 0.1 to about 10 g per kilogram of seed; and vegetative propagation units (e.g., cuttings and tubers) can normally be protected when propagation unit is treated at a rate of from about 0.1 to about 10 g per kilogram of propagation unit.

The mixtures and/or compositions of this invention provide control of diseases caused by a broad spectrum of fungal plant pathogens in the Basidiomycete, Ascomycete, Oomycete and Deuteromycete classes. They are effective in controlling a broad spectrum of plant diseases, foliar pathogens of crops including: cereal grain crops such as wheat, barley, oats, rye, triticale, rice, maize, sorghum and millet; vine crops such as table and wine grapes; field crops such as oilseed rape (canola), sunflower; sugar beets, sugar cane, soybean, peanuts (groundnut), tobacco, alfafa, clover, lespedeza, trefoil and vetch; pome fruits such as apple, pear, crabapple, loquat, mayhaw and quince; stone fruits such as peaches, cherries, plums, apricots, nectarines and almonds; citrus fruits such as lemons, limes, oranges, grapefruit, mandarin (tangerines) and kumquat; root and tuber vegetables and field crops (and their foliage) such as artichoke, garden and sugar beet, carrot, cassava, ginger, ginseng, horseradish, parsnip, potato, radish, rutabaga, sweet potato, turnip and yam; bulb vegetables such as garlic, leek, onion and shallot; leafy vegetables such as arugula (roquette), celery, celery, cress, endive (escarole), fennel, head and leaf lettuce, parsley, radicchio (red chicory), rhubarb, spinach and Swiss chard; brassica (cole) leafy vegetables such as broccoli, broccoli raab (rapini), Brussels sprouts, cabbage, bok choy, cauliflower, collards, kale, kohlrabi, mustard and greens; legume vegetables (succulent or dried) such as lupin, bean (Phaseolus spp.) (including field bean, kidney bean, lima bean, navy bean, pinto bean, runner bean, snap bean, tepary bean and wax bean), bean (Vigna spp.) (including adzuki bean, asparagus bean, black eyed pea, catjang, Chinese longbean, cowpea, crowder pea, moth bean, mung bean, rice bean, southern pea, urd bean and yardlong bean), broad bean (fava), chickpea (garbanzo), guar, jackbean, lablab bean, lentil and pea (Pisum spp.) (including dwarf pea, edible-podded pea, English pea, field pea, garden pea, green pea, snowpea, sugar snap pea, pigeon pea and soybean); fruiting vegetables such as eggplant, groundcherry (Physalis spp.), pepino and pepper (including bell pepper, chili pepper, cooking pepper, pimento, sweet pepper; tomatillo and tomato); cucurbit vegetables such as Chayote (fruit), Chinese waxgourd (Chinese preserving melon), citron melon, cucumber, gherkin, edible gourd (including hyotan, cucuzza, hechima, and Chinese okra), Momordica spp. (including balsam apple, balsam pear, bitter melon and Chinese cucumber), muskmelon (including cantaloupe and pumpkin), summer and winter squash (including butternut squash, calabaza, hubbard squash, acorn squash, spaghetti squash) and watermelon; berries such as blackberry (including bingle berry, boysenberry, dewberry, low berry, Marion berry, olallieberry and youngberry), blueberry, cranberry, currant, elderberry, gooseberry, huckleberry, loganberry, raspberry and strawberry; tree nuts such as almond, beech nut, Brazil nut, butternut, cashew, chestnut, chinquapin, filbert (hazelnut), hickory nut, macadamia nut, pecan and walnut; tropical fruits and other crops such as bananas, plantains, mangos, coconuts, papaya, guava, avocado, lichee, agave, coffee, cacao, sugar cane, oil palm, sesame, rubber and spices; fiber crops such as cotton, flax and hemp; turfgrasses (including warm- and cool-season turf grasses) such as bent grass, Kentucky bluegrass, St. Augustine grass, tall fescue and Bermuda grass.

These pathogens include: Oomycetes, including Phytophthora diseases such as Phytophthora infestans, Phytophthora megasperma, Phytophthora parasitica, Phytophthora cinnamomiand Phytophthora capsici, Pythium diseases such as Pythium aphanidermatum, and diseases in the Peronosporaceae family such as Plasmopara viticola, Peronospora spp. (including Peronospora tabacina and Peronospora parasitica), Pseudoperonospora spp. (including Pseudoperonospora cubensis) and Bremia lactucae; Ascomycetes, including Alternaria diseases such as Alternaria solani and Alternaria brassicae, Guignardia diseases such as Guignardia bidwelli, Venturia diseases such as Venturia inaequalis, Septoria diseases such as Septoria nodorum and Septoria tritici, powdery mildew diseases such as Erysiphe spp. (including Erysiphe graminis and Erysiphe polygoni), Uncinula necatur, Sphaerotheca fuligena and Podosphaera leucotricha, Pseudocercosporella herpotrichoides, Botrytis diseases such as Botrytis cinerea, Monilinia fructicola, Sclerotinia diseases such as Sclerotinia sclerotiorum, Magnaporthe grisea, Phomopsis viticola, Helminthosporium diseases such as Helminthosporium tritici repentis, Pyrenophora teres, anthracnose diseases such as Glomerellaor Colletotrichum spp. (such as Colletotrichum graminicola and Colletotrichum orbiculare), and Gaeumannomyces graminis; Basidiomycetes, including rust diseases caused by Puccinia spp. (such as Puccinia recondita, Puccinia striiformis, Puccinia hordei, Puccinia graminis and Puccinia arachidis), Hemileia vastatrix and Phakopsora pachyrhizi; other pathogens including Rhizoctonia spp. (such as Rhizoctonia solani and Rhizoctonia oryzae); Fusarium diseases such as Fusarium roseum, Fusarium graminearum and Fusarium oxysporum; Verticillium dahliae; Sclerotium rolfsii; Rynchosporium secalis; Cercosporidium personatum, Cercospora arachidicola and Cercospora beticola; Rutstroemia floccosum (also known as Sclerontina homoeocarpa); and other genera and species closely related to these pathogens. In addition to their fungicidal activity, the compositions or combinations also have activity against bacteria such as Erwinia amylovora, Xanthomonas campestris, Pseudomonas syringae, and other related species.

Mixtures of fungicides may provide significantly better disease control than could be predicted based on the activity of the individual components. This synergism has been described as “the cooperative action of two components of a mixture, such that the total effect is greater or more prolonged than the sum of the effects of the two (or more) taken independently” (see Tames, P. M. L., Neth. J. Plant Pathology, (1964), 70, 73-80).

Synergisitic fungitoxic activities were then estimated with the CompuSyn software (Chou et al. 2005, Chou 2006). It was used to determine the Combination Index (CI) for combinations of fungicides and hence the presence of synergism (Cl<1; with values between 0.1-0.3 considered as strong synergism and values <0.1 as very strong synergism; Chou 2008).

Compositions are provided in accordance with this invention that comprise proportions of component (a) and component (b) that are especially useful for controlling particular fungal diseases. These compositions are considered especially useful for controlling Fusarium spp., Geotrichum candidum, Botrytis cinerea, Rhizoctonia solani, Penicillium digitatum Alternaria radicina, Fusarium verticilloides, Penicillium commune, Plectosphaerella cucumerina, Colletotrichum acutatum and Lasiodiplodia pseudotheobromae.

The dose of the synergistic fungicidal composition usually applied in the treatment according to the invention is generally and advantageously from 10 to 800 g/ha, preferably from 50 to 300 g/ha for applications in foliar treatment. The dose of fungicide composition applied is generally and advantageously from 2 to 200 g per 100 kg of seed, preferably from 3 to 150 g per 100 kg of seed in the case of seed treatment.

It is clearly understood that the doses indicated herein are given as illustrative examples of the treatment method according to the invention. A person skilled in the art will know how to adapt the application doses, notably according to the nature of the plant or crop to be treated.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes, which come within the meaning and range of equivalency, are intended to be embraced therein.

The foregoing description will be more fully understood with reference to the following Examples. In the following Examples, all percentages are by weight. Without further elaboration, it is believed that one skilled in the art using the preceding description can utilize the present invention to its fullest extent. The following Examples are, therefore, to be construed as merely illustrative, and not limiting of the disclosure in any way whatsoever.

Percentages are by weight except where otherwise indicated.

### Example 1

Applicants tested the synergy between a mixture of (i) two isothiocyanates molecules (namely 1-isothiocyanato methyl sulfinyl-octane (8MSOH) and 1-isothiocyanato methyl sulfonyl-octane (8MSOOH), at a ratio 8MSOH/8MSOOH 99/1 vol./vol.; this mixture is called “ITO”) and (ii) various commercial fungicides (called “fungicide”; Chlorothanlonil, Dodine, Pyrimethanil, Tebuconazole) that are widely used in agriculture. The mixture of (i) and (ii) is called “combo”.

Applicants selected five different fungal pathogens (see Table 1) that are responsible for important losses in agriculture and that are genetically distant, i.e. from different orders and genera, in order to highlight the versatility of our approach consisting of mixing synthetic fungicides with naturally occurring active ingredients (8MSOH/8MSOOH).

Table 1 List of fungal pathogens used in this example:

TABLE 1

| Species | Family | Order | Class |
|---|---|---|---|
| Alternaria | Pleosporaceae | Pleosporales | Dothideomycetes |
| radicina | | | |
| Geotrichum | Dipodascaceae | Saccharomycesles | Saccharomyces |
| candidum | | | |
| Botrytis | Sclerotiniaceae | Helotiales | Leotiomycetes |
| cinerea | | | |
| Rhizoctonia | Ceratobasidiaceae | Cantharellales | Agaricomycetes |
| solani | | | |
| Penicillium | Trichocomaceae | Eurotiales | Eurotiomycetes |
| digitatum | | | |

All the experiments were done in the same way, with small differences between curative and preventive cases. In 48-well plates, each well was filled with a volume of 180 μL of the ITC, the fungicide or a combination of both at various concentrations and filled with 180 μL of Potato Dextrose Agar (PDA). Three wells were used per concentration for better accuracy. After solidification of the well, either a plug of 2×2 mm of grown fungi (curative case) or 20 μL of a spore solution (˜1E5 spores/mL, preventive case) was placed in each well, and the 48-well plate was sealed with parafilm. After 7 days of incubation at 20° C. in a controlled growth chamber, the fungal outgrowth was measured and the EC50 was calculated with a 4-parameter logistic regression in XLSTAT.

Afterward, a concentration of the fungicides at which the fungi is not growing (i.e. below the EC50) was determined. Applicants repeated the 48-well experiment by filling the well with a mixture of the ITO and the fungicides; the fungicide concentration was kept constant at the determined concentration mentioned above and the ITO concentration was varied. As before, the fungal outgrowth was measured after 7 days of incubation. To calculate the synergistic properties of the combo ITO+fungicides, the Combination Index (CI) described by Chou (2006) was calculated using the CompuSyn software.

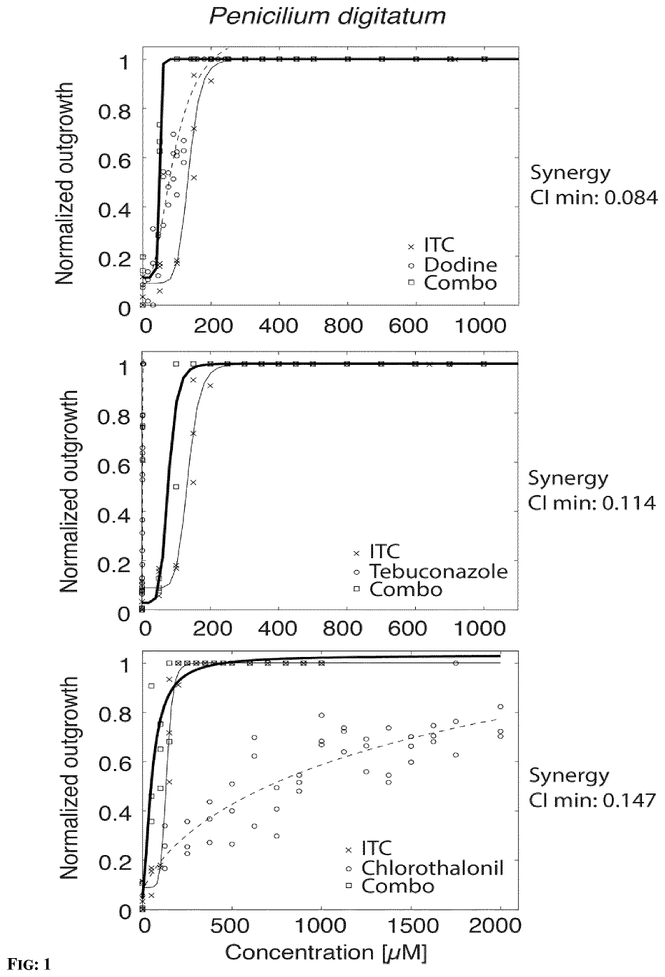

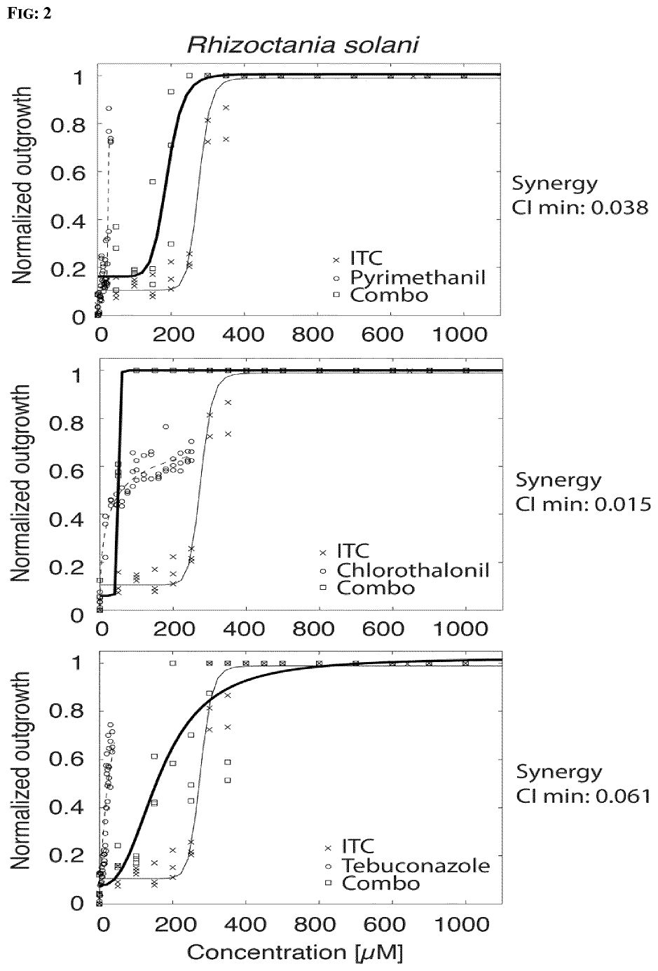

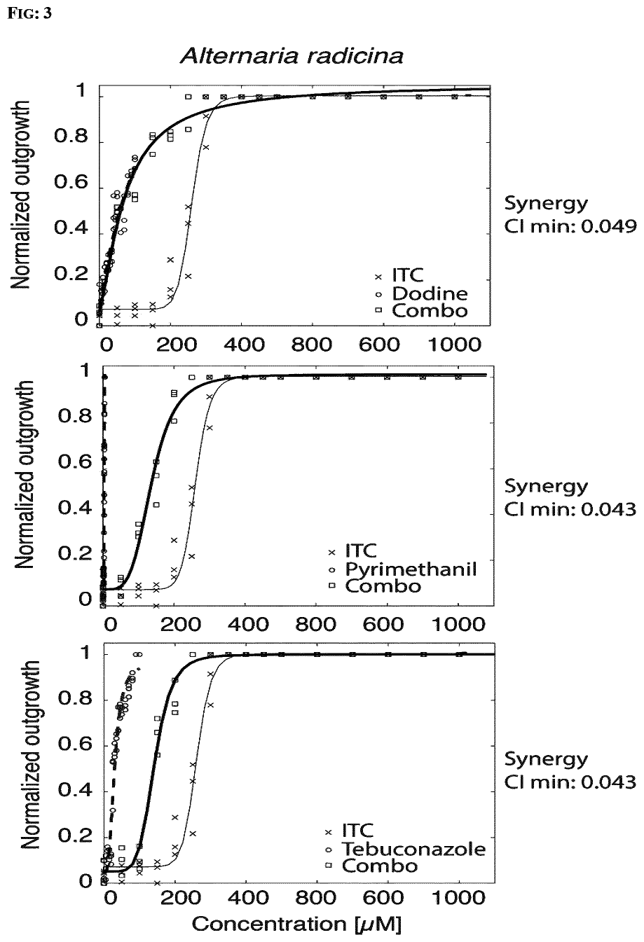

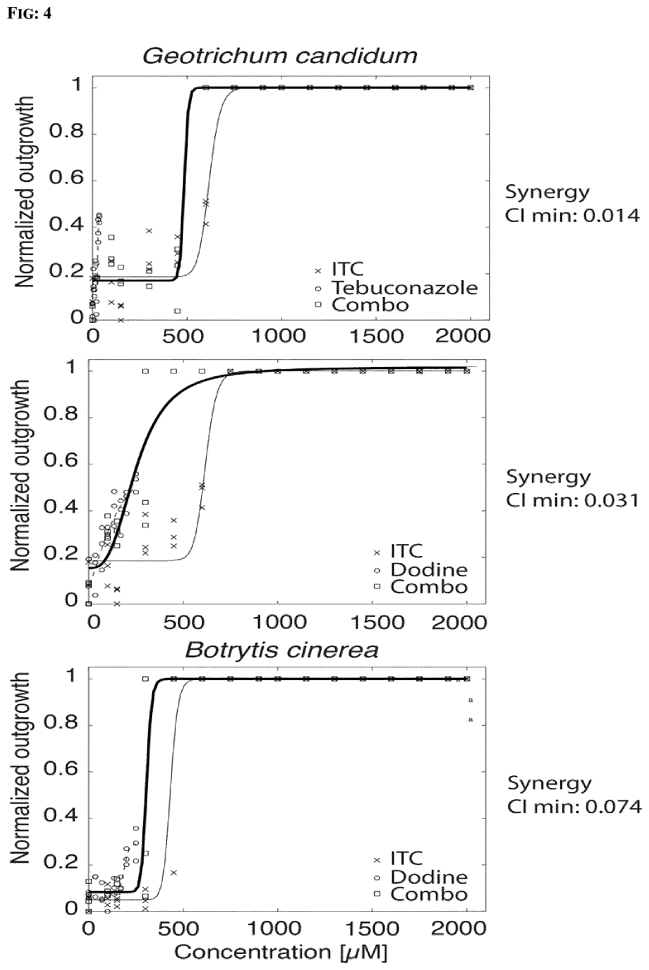

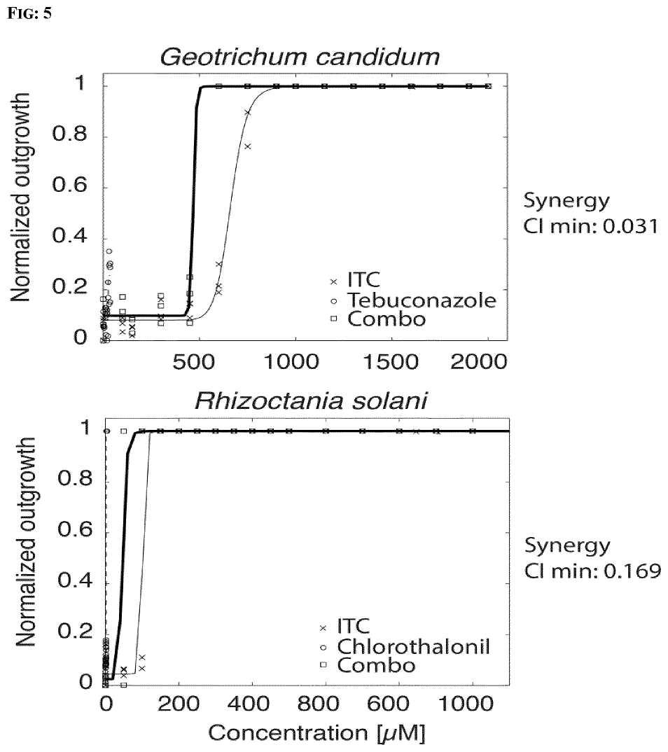

Conclusion: The results clearly demonstrated synergistic effects between the ITO (8MSOH/8MSOOH) and synthetic fungicides when used in combination. Strong synergisms are illustrated by combination index lower than 0.170 (Table 2 and FIGS. 1-5).

TABLE 2

| | | | | | | Fixed | Conc. | |
|---|---|---|---|---|---|---|---|---|
| | | | EC50 | EC50 | EC50 | fungicide | range | |
| | | | ITC | fungicide | combo | conc. | ITC | |
| Fungi | Fungicide | Case | [μM] | [μM] | [μM] | [μM] | [μM] | CI |
| Alternaria radicina | Pyrimethanil | Curative | 260 | 3 | 137 | 1.2 | 0-1000 | 0.043 |
| Alternaria radicina | Tebuconazole | Curative | 260 | 30 | 142 | 15 | 0-1000 | 0.043 |
| Alternaria radicina | Dodine | Curative | 260 | 110 | 70 | 30 | 0-1000 | 0.049 |
| Botrytis cinerea | Dodine | Curative | 433 | 189 | 306 | 70 | 0-2000 | 0.074 |
| Geotrichum candidum | Tebuconazole | Curative | 617 | 27 | 485 | 15 | 0-2000 | 0.049 |
| Geotrichum candidum | Dodine | Curative | 617 | 156 | 252 | 70 | 0-2000 | 0.031 |
| Penicillium digitatum | Tebuconazole | Curative | 135 | 1 | 77 | 0.3 | 0-1000 | 0.114 |
| Penicillium digitatum | Chlorothalonil | Curative | 135 | NA | 52 | 250 | 0-1000 | 0.147 |
| Penicillium digitatum | Dodine | Curative | 135 | 92 | 48 | 35 | 0-1000 | 0.084 |
| Rhizoctonia solani | Pyrimethanil | Curative | 276 | 28 | 189 | 35 | 0-1000 | 0.038 |
| Rhizoctonia solani | Tebuconazole | Curative | 276 | 18 | 168 | 5 | 0-1000 | 0.061 |
| Rhizoctonia solani | Chlorothalonil | Curative | 276 | 29 | 50 | 70 | 0-1000 | 0.015 |
| Geotrichum candidum | Tebuconazole | Preventive | 663 | 25 | 468 | 15 | 0-2000 | 0.031 |
| Rhizoctonia solani | Chlorothalonil | Preventive | 102 | 2 | 46 | 1 | 0-1000 | 0.169 |

TABLE 3

| | | | Weight ratio | Weight ratio |
|---|---|---|---|---|
| Fungi | Fungicide | Case | minimum | maximum |
| Alternaria | Pyrimethanil | Curative | 134:1 | 977:1 |
| radicina | | | | |
| Alternaria | Tebuconazole | Curative | 7:1 | 51:1 |
| radicina | | | | |
| Alternaria | Dodine | Curative | 2:1 | 27:1 |
| radicina | | | | |
| Botrytis | Dodine | Curative | 4:1 | 23:1 |
| cinerea | | | | |
| Geotrichum | Tebuconazole | Curative | 25:1 | 101:1 |
| candidum | | | | |
| Geotrichum | Dodine | Curative | 3:1 | 23:1 |
| candidum | | | | |
| Penicillium | Tebuconazole | Curative | 195:1 | 2529:1 |
| digitatum | | | | |
| Penicillium | Chlorothalonil | Curative | 1:5 | 4:1 |
| digitatum | | | | |
| Penicillium | Dodine | Curative | 1:1 | 23:1 |
| digitatum | | | | |
| Rhizoctonia | Pyrimethanil | Curative | 6:1 | 33:1 |
| solani | | | | |
| Rhizoctonia | Tebuconazole | Curative | 25:1 | 152:1 |
| solani | | | | |
| Rhizoctonia | Chlorothalonil | Curative | 1:1 | 13:1 |
| solani | | | | |
| Geotrichum | Tebuconazole | Preventive | 24:1 | 101:1 |
| candidum | | | | |
| Rhizoctonia | Chlorothalonil | Preventive | 40:1 | 878:1 |
| solani | | | | |

The minimum and maximum weight ratio for each combination ITC:fungicide were calculated as follow. The minimum concentration of the ITC was chosen as the EC50 of the combo (ITC+fungicide), and the maximum one as the highest concentration of ITC tested. As the fungicide concentration was kept fixed for a given fungi, only the ITC concentration varied. These molar concentrations were multiplied by the molecular weight of the compounds to obtain mass concentrations. Finally, the weight ratio ITC:fungicide was obtained by dividing the mass concentration of the ITC by the mass concentration of the fungicides, for both the minimum and the maximum ITC concentration.

Table 4 Minimum and maximum weight ratios that were calculated in respect of the 4 following fungicides:

TABLE 4

| | Weight ratio | Weight ratio |
|---|---|---|
| Fungicide | minimum | maximum |
| Pyrimethanil | 6:1 | 980:1 |
| Tebuconazole | 7:1 | 2500:1 |
| Dodine | 1:1 | 27:1 |
| Chlorothalonil | 1:5 | 880:1 |

The minimum and maximum concentration ratio for each combination ITC fungicide were calculated as follow. The minimum concentration of the ITC was chosen as the EC50 of the combo (ITC+fungicide), and the maximum one as the highest concentration of ITC tested. As the fungicide concentration was kept fixed for a given fungi, only the ITC concentration varied. The concentration ratio ITC:fungicide was obtained by dividing the molar concentration of the ITC by the molar concentration of the fungicides, for both the minimum and the maximum ITC concentration.

Table 5 Minimum and maximum concentration ratios that were calculated in respect of the 4 following fungicides:

TABLE 5

| | Concentration | Concentration |
|---|---|---|
| Fungicide | ratio minimum | ratio maximum |
| Pyrimethanil | 5:1 | 830:1 |
| Tebuconazole | 9:1 | 3300:1 |
| Dodine | 1:1 | 33:1 |
| Chlorothalonil | 1:4 | 1000:1 |

### Example 2

Applicants tested the synergy between a mixture of (i) two isothiocyanates molecules (namely 1-isothiocyanato methyl sulfinyl-octane (8MSOH) and 1-isothiocyanato methyl sulfonyl-octane (8MSOOH), at a ratio 8MSOH/8MSOOH 99/1 vol./vol.; this mixture is called “ITC”) and (ii) various commercial fungicides (referred herein as “fungicide”; Captan, Cyprodinil, Fludioxonil, Fluxapyroxad, Chlorothalonil, Dodine, Tebuconazole, Mancozeb) that are widely used in agriculture. The mixture of (i) and (ii) is called “combo”.

Applicants selected five different fungal pathogens (see Table 1) that are responsible for important losses in agriculture and that are genetically distant, i.e. from different orders and genera, in order to highlight the versatility of our approach consisting of mixing synthetic fungicides with naturally occurring active ingredients (8MSOH/8MSOOH).

Table 6: List of fungal pathogens used in this example.

TABLE 6

| Species | Family | Order | Class |
|---|---|---|---|
| Fusarium | Netriaceae | Hyprocreales | Sordariomycetes |
| verticilloides | | | |
| Penicillium | Trichocomaceae | Eurotiales | Eurotiomycetes |
| commune | | | |
| Plectosphaerella | Plectosphaerellaceae | Xylariales | Sordariomycetes |
| cucumerina | | | |
| Colletotrichum | Glomerellaceae | Glomerellales | Sordariomycetes |
| acutatum | | | |
| Lasiodiplodia | Botryosphaeraceae | Botryosphaeriales | Dothideomycetes |
| pseudotheobromae | | | |

All the experiments were done in the same way. In 48-well plates, each well was filled with a volume of 180 μL of the ITC, the fungicide or a combination of both at various concentrations and filled with 180 μL of Potato Dextrose Agar (PDA). Two or three wells were used per concentration for better accuracy. After solidification of the well a plug of 2×2 mm of grown fungi was placed in each well, and the 48-well plate was sealed with parafilm. After 7 days of incubation at room temperature, the fungal outgrowth was measured and the EC50 was calculated with a 4-parameter logistic regression in XLSTAT.

Afterward, a concentration of the fungicides at which the fungi is not growing (i.e. below the EC50) was determined. Applicants repeated the 48-well experiment by filling the well with a mixture of the ITC and the fungicides; the fungicide concentration was kept constant at the determined concentration mentioned above and the ITC concentration was varied. As before, the fungal outgrowth was measured after 7 days of incubation. To calculate the synergistic properties of the combo ITC+fungicides, the Combination Index (CI) described by Chou (2006) was calculated using the CompuSyn software.

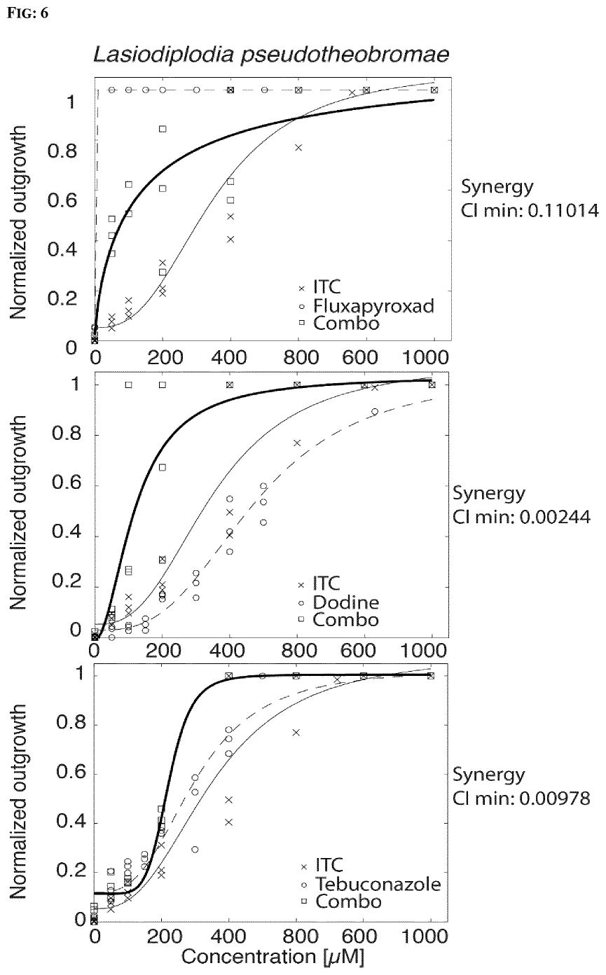

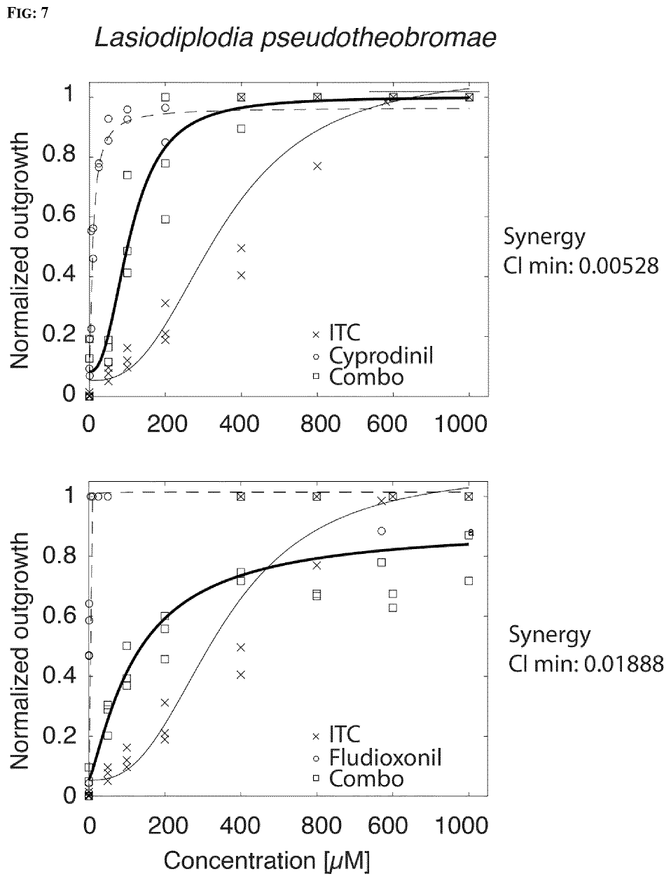

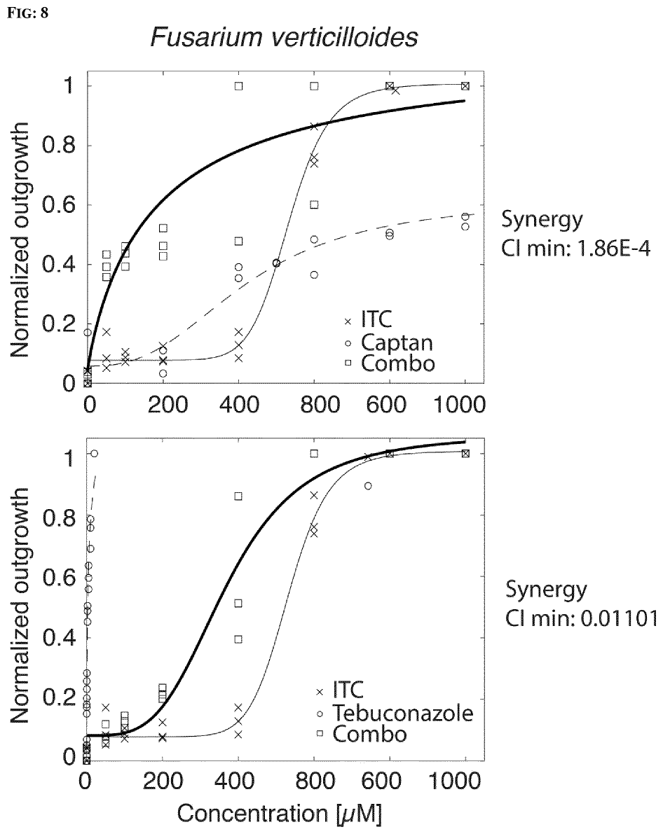

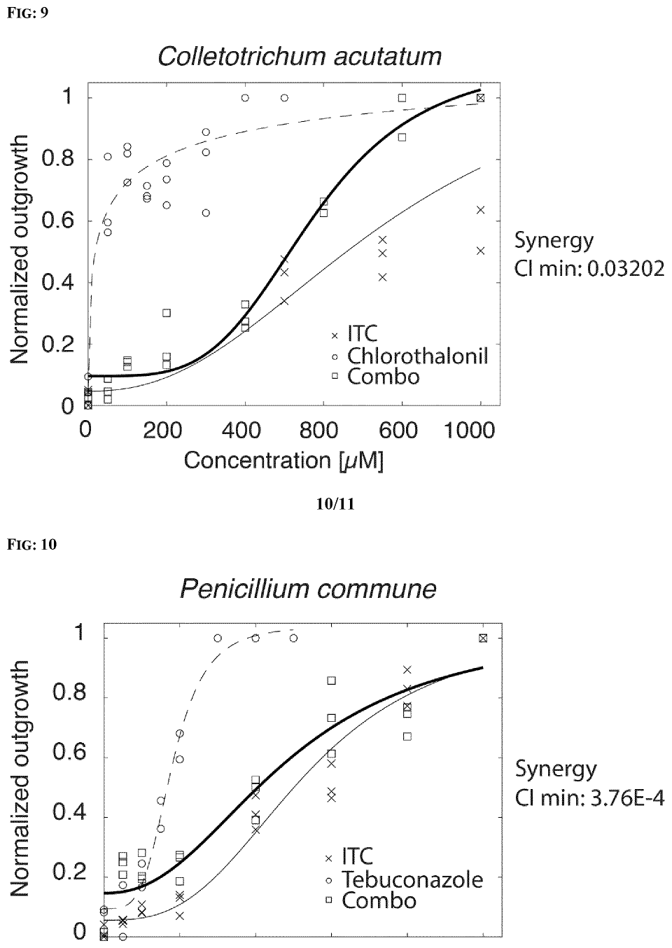

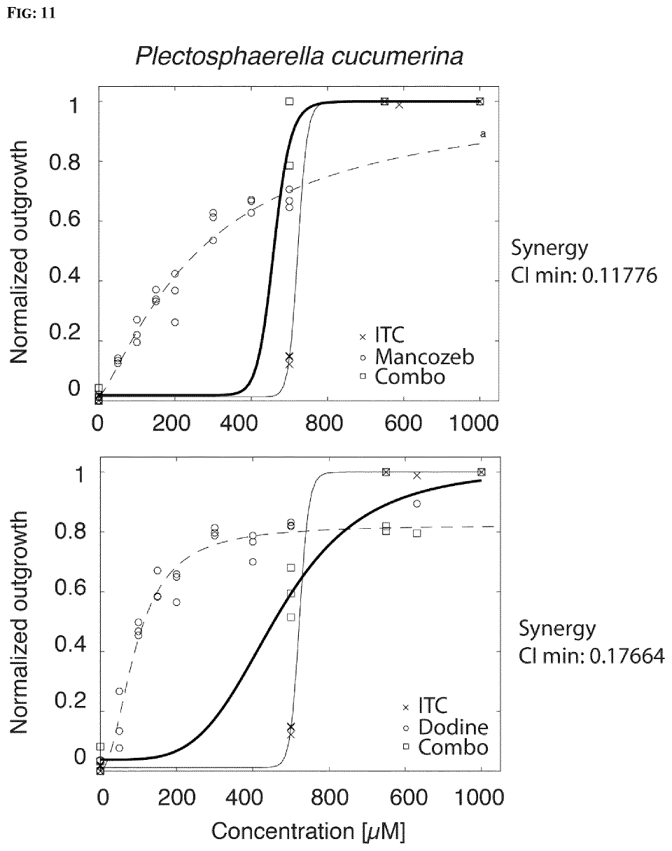

Conclusion: The results clearly demonstrated synergistic effects between the ITC (8MSOH/8MSOOH) and synthetic fungicides when used in combination. Strong synergisms are illustrated by combination index lower than 0.170 (Table 7 and FIGS. 6 to 11).

TABLE 7

| | | | | | Fixed | Conc. | |
|---|---|---|---|---|---|---|---|
| | | EC50 | EC50 | EC50 | fungicide | range | |
| | | ITC | fungicide | combo | conc. | ITC | |
| Fungi | Fungicide | [mM] | [mM] | [mM] | [mM] | [mM] | CI |
| C. acutatum | Chlorothalonil | 788 | 52 | 573 | 35 | 0-1000 | 0.03202 |
| F. verticilloides | Tebuconazole | 533 | 6 | 370 | 5 | 0-1000 | 0.01101 |
| F. verticilloides | Captan | 533 | 424 | 182 | 370 | 0-1000 | 0.000186 |
| L. pseudotheobromae | Dodine | 352 | 476 | 120 | 125 | 0-1000 | 0.00244 |
| L. pseudotheobromae | Tebuconazole | 352 | 300 | 221 | 75 | 0-1000 | 0.00978 |
| L. pseudotheobromae | Fluxapyroxad | 352 | 35 | 132 | 20 | 0-1000 | 0.11014 |
| L. pseudotheobromae | Fludioxonil | 352 | 1 | 127 | 0.3 | 0-1000 | 0.01888 |
| L. pseudotheobromae | Cyprodinil | 352 | 9 | 108 | 5 | 0-1000 | 0.00528 |
| P. commune | Tebuconazole | 536 | 179 | 490 | 100 | 0-1000 | 3.76E−04 |
| P. cucumerina | Mancozeb | 522 | 459 | 277 | 80 | 0-1900 | 0.11776 |
| P. cucumerina | Dodine | 522 | 93 | 467 | 15 | 0-1900 | 0.17664 |

Table 7: Fungal pathogen tested in curative, EC56 of the IT1 (8MSOH/8MSOOH) and synthetic fungicides) alone and in combination, fixed synthetic fungicide concentration used in the combination, concentration range of the ITO used in the combination and synergistic effect (lowest combination index; Cl).

Table 8: Summary of the minimum and maximum weight ratios ITO:fungicide for the examples used in Table 7.

TABLE 8

| | | Weight ratio | Weight ratio |
|---|---|---|---|
| Fungi | Fungicide | minimum | maximum |
| C. acutatum | Chlorothalonil | 14:1 | 25:1 |
| F. verticilloides | Tebuconazole | 56:1 | 152:1 |
| F. verticilloides | Captan | 1:1 | 2:1 |
| L. pseudotheobromae | Dodine | 1:1 | 6:1 |
| L. pseudotheobromae | Tebuconazole | 2:1 | 10:1 |
| L. pseudotheobromae | Fluxapyroxad | 4:1 | 31:1 |
| L. pseudotheobromae | Fludioxonil | 398:1 | 3137:1 |
| L. pseudotheobromae | Cyprodinil | 22:1 | 207:1 |
| P. commune | Tebuconazole | 4:1 | 8:1 |
| P. cucumerina | Mancozeb | 1:1 | 10:1 |
| P. cucumerina | Dodine | 25:1 | 103:1 |

The minimum and maximum weight ratio for each combination ITO:fungicide were calculated as follow. The minimum concentration of the ITO was chosen as the EC50 of the combo (ITO+fungicide), and the maximum one as the highest concentration of ITO tested. As the fungicide concentration was kept fixed for a given fungi, only the ITO concentration varied. These molar concentrations were multiplied by the molecular weight of the compounds to obtain mass concentrations. Finally, the weight ratio ITO:fungicide was obtained by dividing the mass concentration of the ITO by the mass concentration of the fungicides, for both the minimum and the maximum ITO concentration.

Table 9 Minimum and maximum weight ratios that were calculated in respect of the 8 following fungicides:

TABLE 9

| | Weight ratio | Weight ratio |
|---|---|---|
| Fungicide | minimum | maximum |
| Chlorothalonil | 14:1 | 25:1 |
| Tebuconazole | 2:1 | 152:1 |
| Captan | 1:1 | 2:1 |
| Dodine | 1:1 | 103:1 |
| Fluxapyroxad | 4:1 | 31:1 |
| Fludioxinil | 398:1 | 3137:1 |
| Cyprodinil | 22:1 | 207:1 |
| Mancozeb | 1:1 | 10:1 |

The minimum and maximum concentration ratio for each combination ITO fungicide were calculated as follow. The minimum concentration of the ITO was chosen as the EC5 of the combo (ITO+fungicide), and the maximum one as the highest concentration of ITO tested. As the fungicide concentration was kept fixed for a given fungi, only the ITO concentration varied. The concentration ratio ITO:fungicide was obtained by dividing the molar concentration of the ITO by the molar concentration of the fungicides, for both the minimum and the maximum ITO concentration.

Table 10: Minimum and maximum concentration ratios that were calculated in respect of the 8 following fungicides:

TABLE 10

| | Concentration | Concentration |
|---|---|---|
| Fungicide | ratio minimum | ratio maximum |
| Chlorothalonil | 16:1 | 29:1 |
| Tebuconazole | 3:1 | 200:1 |
| Captan | 1:1 | 3:1 |
| Dodine | 1:1 | 127:1 |
| Fluxapyroxad | 7:1 | 50:1 |
| Fludioxinil | 423:1 | 3333:1 |
| Cyprodinil | 22:1 | 200:1 |
| Mancozeb | 3:1 | 24:1 |

### REFERENCES

Chou, T. C., Martin, N., 2005. CompuSyn for drug combinations: PC software and user's guide: A Computer Program for quantitation of synergism and antagonism in drug combinations, and the determination of IC50 and ED50 and LD50 values. ComboSyn Inc, Paramus, NJ.
Chou, T. C., 2006. Theoretical basis, experimental design, and computerized simulation of synergism and antagonism in drug combination studies. Pharmacol Rev. 58, 621-81.
Chou, T. C., 2008. Preclinical versus clinical drug combination studies. Leuk Lymph. 49, 2059-2080.

1. A synergistic fungicidal composition comprising:
(a) at least one component being the mixture of 1-isothiocyanato-8(methylsulfonyl)-octane (8MSOOH) and 1-isothiocyanato-8-(methylsulfinyl)-octane (8MSOH); and
(b) at least one additional synthetic fungicidal component selected from Mancozeb, Dodine, Chlorothalonil, Tebuconazole, Captan, Cyprodinil, Fludioxonil, Fluxypyroxad and Pyrimethanil, salts thereof or mixtures thereof.

2. The synergistic fungicidal composition of claim 1, wherein component (b) is selected from Mancozeb, Dodine, Chlorothalonil, Tebuconazole, Captan, Cyprodinil, Fludioxonil, Fluxypyroxad and Pyrimethanil.

3. The synergistic fungicidal composition of claim 2, wherein component (b) is selected from Tebuconazole, Captan, Cyprodinil and Dodine.

4. A synergistic fungicidal composition of claim 1, wherein component (a) is present at a ratio 1-isothiocyanato methyl sulfinyl-octane/1-isothiocyanato methyl sulfonyl-octane of 99/1 vol./vol.

5. The synergistic fungicidal composition of claim 1, further comprising at least one additional component selected from the group consisting of a surfactant, a solid diluent and/or a liquid diluent.

6. The synergistic fungicidal composition of claim 1, wherein the weight ratio of component (a) to component (b) is from 1:5 to 3137:1.

7. The synergistic fungicidal composition of claim 1, wherein the weight ratio of component (a) to pyrimethanil is from 6:1 to 980:1.

8. The synergistic fungicidal composition of claim 1, the wherein weight ratio of component (a) to Tebuconazole is from 2:1 to 2500:1.

9. The synergistic fungicidal composition of claim 1, wherein the weight ratio of component (a) to dodine is from 1:1 to 103:1.

10. The synergistic fungicidal composition of claim 1, wherein the weight ratio of component (a) to mancozeb is from 1:1 to 10:1.

11. The synergistic fungicidal composition of claim 1, wherein the weight ratio of component (a) to captan is from 1:1 to 2:1.

12. The synergistic fungicidal composition of claim 1, wherein the weight ratio of component (a) to cyprodinil is from 22:1 to 207:1.

13. The synergistic fungicidal composition of claim 1, wherein the weight ratio of component (a) to fludioxonil is from 398:1 to 3137:1.

14. The synergistic fungicidal composition of claim 1, wherein weight ratio of component (a) to fluxapyroxad is from 4:1 to 31:1.

15. The synergistic fungicidal composition of claim 1, wherein the weight ratio of component (a) to chlorothalonil is from 1:5 to 880:1.

16. A method for controlling a plant disease caused by a fungal plant pathogen comprising applying to the plant or portion thereof, or to the plant seed, a fungicidally effective amount of the synergistic fungicidal composition of claim 1.

17. The method of claim 16, wherein the fungal plant pathogen is selected from the group consisting of Fusarium spp., Geotrichum candidum, Botrytis cinerea, Rhizoctonia solani, Penicillium digitatum Alternaria radicina, Fusarium verticilloides, Penicillium commune, Plectosphaerella cucumerina, Colletotrichum acutatum and Lasiodiplodia pseudotheobromae.

18. Use of a synergistic composition comprising the combination of:
(a) at least one component being the mixture of 1-isothiocyanato-8(methylsulfonyl)-octane (8MSOOH) and 1-isothiocyanato-8-(methylsulfinyl)-octane (8MSOH); and
(b) at least one additional synthetic fungicidal component selected from Mancozeb, Dodine, Chlorothalonil, Tebuconazole, Captan, Cyprodinil, Fludioxonil, Fluxypyroxad and Pyrimethanil, in the prevention or treatment of fungal pathogens in plants.

19. The use of the synergistic composition according to claim 18, wherein component (a) is present at a ratio 1-isothiocyanato methyl sulfinyl-octane/1-isothiocyanato methyl sulfonyl-octane of 99/1 vol./vol.

20. The use of the synergistic composition of claim 18, further comprising at least one additional component selected from the group consisting of a surfactant, a solid diluent and/or a liquid diluent.

21. The use of the synergistic composition of claim 18, wherein the weight ratio of component (a) to component (b) is from 1:5 to 3137:1.
